(19) United States
(12) Patent Application Publication
(10) Pub. No.: US 2008/0299260 A1
(43) Pub. Date: Dec. 4, 2008

(54) EXTRUDED PET FOOD PRODUCT

(75) Inventor: Curtis J. Strahm, Kansas City, MO (US)

Correspondence Address: HOVEY WILLIAMS LLP, 10801 Mastin Blvd., Suite 1000, Overland Park, KS, 66210, US

(73) Assignee: Wenger Manufacturing, Inc., Sabetha, KS (US)

(21) Appl. No.: 12/116,851

(22) Filed: May 7, 2008

Related U.S. Application Data
(60) Provisional application No. 60/938,390, filed on May 16, 2007.

(51) Int. Cl. A23K 1/16; A23K 1/14; A23K 1/10

(52) U.S. Cl. 426/72; 426/656; 426/104

(57) ABSTRACT

Combined extruded petfood products which include respective amounts of a plurality of simulated, extrusion-produced food materials each having the appearance of the natural food counterpart thereof, and each preferably having the same, shape, size, color, texture, and taste of such counterparts. Preferably, the petfood products have at least two simulated vegetable materials therein (e.g., corn, rice, peas, carrots, and beans). Additionally, the petfood products may include simulated meat materials likewise having properties closely similar to their natural meat counterparts. Other combined food products may include extruded kibble containing protein, fat, and starch, as well as an extruded rice and textured vegetable protein components which are treated with humectant and acidulent.

### CROSS-REFERENCE TO RELATED APPLICATION

This application claims the benefit of Provisional Application Ser. No. 60/938,390, filed May 16, 2007, and such Provisional Application is incorporated by reference herein in its entirety.

### BACKGROUND OF THE INVENTION

1. Field of the Invention

The present invention is broadly concerned with novel pet food products and methods of fabrication thereof. More particularly, the invention is concerned with pet food products having conventional extruded kibble feed in combination with humectant-treated rice and textured vegetable protein (TVP) extruded components. In another aspect of the invention, combined petfoods are provided having a plurality of individual, separately extruded food materials, each having the appearance of their natural food counterparts, so that the combined petfood gives the appearance of containing such natural food counterparts.

2. Description of the Prior Art

Extruded pet feeds for dogs and cats are extremely common, generally these products contain protein, fat and starch, and can be relatively hard or of semi-moist consistency. The technology of these extruded feeds is well understood in the art.

Many consumers believe that standard extruded kibble pet feeds are of low quality, a perception fostered by the fact that a large variety of these feeds are readily available on the commercial market. However, consumers often believe that the presence of rice and/or meat or meat-like chunk components in pet foods is a decided advantage, from the standpoints of palatability and nutritional benefits. Accordingly, consumers are often willing to pay a premium price for such feeds.

There is also a recent trend among pet owners referred to as the “humanization” of pets. As a corollary to this trend, many pet owners would like to feed their pets foods which appear to contain materials common to the owner's own diet. For example, petfoods can be provided which include naturally occurring vegetables (e.g., corn, rice, and/or peas). These foods in their natural state may not be nutritionally optimum for pets, and use of these natural products can be both very expensive and require special handling and storage such as continual refrigeration.

Heretofore, pet feeds of the extruded kibble variety have not included these premium ingredients, because of cost considerations and because of the belief that the presence of these components would unacceptably shorten the shelf lives of the final products.

### SUMMARY OF THE INVENTION

The present invention overcomes the problems outlined above and provides improved pet feed products, specially designed for domestic pets such as dogs and cats. In one aspect, the pet feeds of the invention are made up of an essentially standard or conventional hard or semi-moist kibble component, a rice component, and a TVP component. All of these components are individually extruded and cooked, and are ultimately combined to form the feeds of the invention. As used herein, “combined” refers to a physical combination of the ingredients, or in a diet wherein the individual ingredients are simultaneously presented to an animal in separate portions (e.g., a compartmentalized tray could be provided having individual pockets for the kibble, rice and TVP components, and such would be considered a “combined” feed product). Preferably, the rice and TVP components are treated with humectant and acidulant ingredients in order to stabilize the water activities thereof and to impart a degree of softness and chewability to these components.

The kibble component of the combined feeds is itself entirely conventional and includes respective quantities of protein, fat, and starch. This kibble product can be of variable size, but typically has a length of from about ⅛-¾ inch and is in the form of cubes or elongate bodies.

The rice component contains a very high proportion of rice, typically at least about 90% by weight. The starting material for this component may be whole rice or dehulled and debranned rice or rice flour. Rice flour is the most preferred ingredient. The rice is normally supplemented by a food-grade surfactant such as monoglyceride, as well as an anti-microbial such as potassium sorbate. The starting rice mixture is preferably preconditioned and extruded to create a final product having the appearance of natural rice. A humectant/acidulant mixture may be incorporated into the starting rice ingredients during preconditioning and/or extrusion, or maybe applied directly to the final extruded rice product. A variety of humectants can be used in this context, for example: glycerin; the alkylene glycols (e.g., C3-C6 alkylene glycols including propylene glycol); the glyceryl acetates (e.g., glyceryl triacetate), the polyols (e.g., sorbitol, xylitol, maltitol); the polymeric polyols (e.g., polydextrose); the natural extracts (e.g., quillaia, lactic acid, or urea); and mixtures thereof. The humectant may be used at a level of from about 8-35% by weight, based upon the total weight of the extruded rice product taken as 100% by weight.

The acidulant can be any one of a number of food-grade acidulants, such as: acetic, citric, fumaric, lactic, malic, phosphoric, and tartaric acids and mixtures thereof. Phosphoric acid is the single most preferred acidulant. The acidulant is generally used at a lesser level than the humectant, typically from about 1-10% by weight, based upon the total weight of the extruded rice product taken as 100% by weight. Preferably, the humectant and acidulant are incorporated into the rice ingredients or applied to the final rice extrudate as a combined liquid.

The TVP component normally includes a major proportion of vegetable protein which may be texturized in an extrusion process. The most common vegetable protein source is soy, in the form of soy flour, soy concentrate, soy isolate, or mixtures thereof. However, other vegetable protein sources such as wheat, oats, sorghum, and barley may also be used in combination with or in lieu of soy. The TVP component also preferably includes minor proportions of fresh meat (e.g., beef or poultry), sulphur and colorants (e.g., titanium dioxide and/or food-grade dyes). The process for producing the TVP component is well known and involves extrusion of the selected TVP starting ingredients under relatively high temperature and specific mechanical energy input conditions so as to texturize and denature the protein.

As in the case of the rice component, the TVP component is treated with humectant and acidulant by incorporation thereof into the material during processing, or as a final topical application post-extrusion. The humectant and acidulant ingredients described above in connection with the rice component, as well as the levels of use thereof, can also advantageously employed with the TVP component.

A major advantage with the present invention is that the rice and TVP can be extruded and cooled without the need for post-extrusion drying. Thus, the normal energy costs associated with such drying are entirely eliminated.

In order to produce the combined final product, it is only necessary to mix together the desired proportions of the kibble, rice and TVP components, with adequate mixing to assure substantial homogeneity. These final products have substantial shelf-stability and are highly palatable.

In another aspect of the invention, combined petfood products are provided comprising respective amounts of a plurality of simulated food materials each separately formed and cooked by extrusion, and each having the appearance of the natural food counterpart thereof, the plurality of simulated food materials including at least two different simulated vegetable materials. For example, extruded simulated vegetable materials may be selected from the group consisting of corn, rice, peas, carrots, and beans, and these simulated materials preferably have the shape, size, color, and taste of their natural counterparts. Thus, using appropriate extrusion techniques, simulated corn and rice materials may be produced for example which very closely simulate the properties of naturally occurring corn and rice.

It is also possible to include in such petfood products one or more simulated, cooked and extruded meat materials likewise having the appearance of their natural food counterparts. Such simulated meats are typically selected from the group consisting of beef, pork, poultry, lamb, and fish. Again, it is particularly preferred that such simulated meat materials have the shape, size, color, texture, and taste of their natural meat counterparts. Also, quantities of fresh, naturally occurring meat can be added to the petfood products.

During extrusion, it is also possible to supplement the simulated food materials with a variety of nutraceuticals, such as vitamins and minerals. This is often desirable so as to create a nutritionally balanced petfood product.

These simulated material petfood products can also be premixed and served as a combined product, or may be maintained separately in a feeding tray or the like having individual compartments for each of the food materials.

### DETAILED DESCRIPTION OF THE PREFERRED EMBODIMENT

The following examples set forth possible feed component recipes and methods of manufacture thereof in accordance with the invention. It is to be understood, however, that these examples are provided by way of illustration and nothing therein should be taken as a limitation upon the overall scope of the invention.

### Example 1

### Production of Humectant-Treated Rice Components

In these examples a Wenger/Extru-Tech Model E-325 extruder is used having a 5-head extruder set up and configuration. An Extru-Tech Model 30 bin and feeder, and a 10×45 dual preconditioning device are located upstream of the extruder. The extruder is driven by a V-belt assembly using a 60 hp main drive motor with an AC variable frequency drive. The extruder is equipped with a conventional rice die and knife cut off assembly. The preconditioner and extruder barrel are equipped with steam and liquid injection manifolds.

In one process designed to produce a dense, semi-moist, rice-shaped extrudate, a formula made up of 99.1% by weight rice flour, 0.57% by weight monoglyceride, and 0.34% by weight potassium sorbate is used as the starting mixture. This mixture is fed through the preconditioner/extruder assembly at a rate of from about 150-500 pounds per hour, with an extruder shaft feed of from about 250-800 rpm, more preferably 500-800 rpm. The specific mechanical energy input in the extruder is from about 10-20 kw/hr/ton of starting mixture. The mixture is subjected to a maximum temperature in the extruder of from about 200-280° F. and the residence time in the extruder barrel is from about 90-120 seconds. The starting mixture contains from about 10-12% by weight native water and an additional 3-8% water is added, together with from about 6-8% by weight steam, in the preconditioner and/or extruder to moisturize the starting mixture.

A liquid additive made up of 89.5% by weight propylene glycol and 10.5% by weight phosphoric acid is used at a level from about 10-20% of the incoming dry feed rate to the preconditioner/extruder assembly. This additive may be incorporated directly into the rice material while the latter passes through the preconditioner and/or extruder barrel. Alternately, some or all of this liquid additive may be applied by spraying or the like to the extruded rice product after passage from the rice die.

In order to produce a light density, semi-moist rice product, the foregoing materials, equipment, and processing conditions are followed, except that the extruder shaft is rotated at from about 250-1200 rpm (more preferably 500-1200 rpm) and a specific mechanical energy input of from about 30-60 kw/hr/ton is employed. As in the case of the dense product, the humectant/acidulant blend is added either during preconditioning, extrusion, and/or as a topical application after extrusion.

The extruded rice products described above are preferably cooled after extrusion to approximately ambient temperature. Generally, there is no need to further dry the products and in fact such would add unnecessary cost to the products. The final moisture content of the cooled rice products is typically in the range of about 18-30% by weight, and has a moisture activity of below about 0.65.

### Example 2

### Production of Textured Vegetable Protein Components

Production of these components is carried out using the same equipment described in Example 1 except that a standard textured vegetable protein chunk die is used in lieu of the rice die. The incoming feed to the preconditioner/extruder assembly has 70.69% by weight defatted soy flour, 5.0% by weight fresh ground turkey meat, 0.1% by weight sulphur, 20.0% by weight wheat gluten, 4.0% by weight soft wheat flour, 0.2% titanium dioxide, and 0.01% by weight a yellow dye No. 5. The system is operated at a feed rate of 150-500 pounds per hour of the incoming feed material at an extruder shaft rotation of from about 250-1200 rpm (more preferably 800-1200 rpm) and with a specific mechanical energy input of from about 80-120 kw/hr/ton, The incoming feed material is moisturized in the preconditioner and/or extruder barrel using 8-12% by weight injected water and from about 6-8% by weight injected steam. The mixture is subjected to a maximum temperature in the extruder of from about 200-280° F. and the residence time in the extruder barrel is from about 90-120 seconds. The humectant/acidulent mixture described in Example 1 is either incorporated into the starting feed materials during preconditioning and/or extrusion, and/or may be applied topically after extrusion. The resultant product is in the form of ¼-½ inch chunks.

As in the case of the rice component, there is generally no need to further dry the TVP product, and simple air cooling is sufficient. The final cooled TVP product has a moisture content of from about 18-29% by weight and a water activity of below about 0.65.

### Example 3

### Production of Final Feed Products

The rice and textured vegetable proteins components described in Examples 1 and 2 are mixed with a standard extruded pet food kibble product containing respective quantities of protein, fat, and starch. Typical formulas for hard kibble and semi-moist extruded kibble products are set forth below:

PETFOOD - DRY KIBBLE

| Raw Ingredients | % by wt. |
|---|---|
| Corn | 22.20 |
| Rice | 22.20 |
| Meat & Bone Meal | 16.70 |
| Poultry Meal | 16.70 |
| Fresh Chicken Meat | 19.40 |
| Tallow | 2.80 |

PETFOOD - SEMI-MOIST

| Raw Ingredients | % by wt. |
|---|---|
| Corn Flour | 38.26 |
| Soy Flour | 20.00 |
| Oat Flour | 12.00 |
| Sugar | 5.00 |
| Salt | 1.50 |
| Potassium Sorbate | 0.20 |
| Red #40 | 0.04 |
| Meat & Bone Meal | 10.50 |
| Propylene Glycol | 6.00 |
| Phosphoric Acid | 1.50 |
| Tallow | 5.00 |

The relative proportions of the kibble, rice product and TVP components is variable depending upon the cost of production of the respective components, and the desired characteristics in a final feed. For example, it is contemplated that the rice and TVP components can each be used at a level of from about 2-40% by weight, more preferably from about 5-20% by weight based upon the total weight of the combined feed product taken as 100% by weight. In this connection, it is believed that a highly palatable final feed would contain ⅓ rd by weight each of the kibble, rice and TVP components.

### Example 4

### Production of Simulated Corn

In this example a starting recipe of 100% by weight corn (approximately 12% oil) was extruded using a specialized die to create an extrudate having the shape and color of corn kernels. The starting material was initially fed through a Wenger DDC preconditioner, where it was moisturized and partially cooked. Steam was added to the preconditioner, and the rotating paddles were operated at a speed of 315 rpm. At the exit of the preconditioner the product had a temperature of 94° C. and a moisture content of 19.52% wb. The preconditioned product was then fed to a Wenger Model X20 single screw extruder operated at a shaft speed of 450 rpm, with an extruder motor load of 18 amps. Steam was added to the extruder at a rate of 7.4 kg/hr. The first and second operating heads downstream of the inlet head were controlled by passing cold water through the external jackets thereof. The corn kernel-shaped extrudate issuing from the extruder die had a moisture content of 19.54% wb and a density of 390 kg/m³.

The extruded product was then dried in a three-pass dryer at 90° C. and a retention time of 8.6 minutes (pass one), 8.3 minutes (pass two), and 8 minutes (pass three). The final product had a density of 436 kg/m³ and a moisture content of 9.34% wb.

### Example 5

### Production of Simulated Rice

A starting recipe made up of 99.09% by weight rice flour, 0.57% by weight monoglyceride, and 0.34% by weight potassium sorbate was used in this example. The recipe was initially preconditioned in a Wenger DDC preconditioner with steam addition at 16 kg/hr and water addition at 15 kg/hr. The preconditioned product had a temperature of 90° C. and a moisture content of 26.72% wb. The preconditioned material was then fed into a Wenger X20 single screw extruder operated at a shaft speed of 300 rpm and a motor load of 45%. Water was added to the extruder at a rate of 6 kg/hr. The second, fourth, and fifth heads of the extruder were operated at 20° C., 28° C., and 82° C., respectively. The head pressure was recorded at 5171.25 kPa. The extruder die formed the product into a simulated rice grain configuration and a cut-off knife operated at 250 rpm was used to separate the product into individual grains. The product exiting the extruder had a moisture content of 27.54% wb. The extruded product was then passed through a cooler which reduced the moisture content thereof to 25.11% wb.

### Example 6

### Production of Simulated Meat

In this example a textured vegetable simulated meat product was produced using a starting recipe of 60% by weight wheat gluten, 22% by weight soy flour, 15% by weight wheat flour, 1.90% by weight trisodium phosphate, 1.0% by weight salt, and 0.10% by weight sulfur. A second recipe made up of 100% by weight beef/pork liver blend was also used.

In the first step the wheat gluten recipe was fed to a Wenger DDC preconditioner at a rate of 570 kg/hr. The preconditioner was operated at a speed of 250 rpm with steam flow added at a rate of 27 kg/hr. The liver blend recipe was also added to the preconditioner at a rate of 300 kg/hr. The resultant preconditioned product had a discharge temperature of 60° C. The preconditioned material was then fed to a Wenger twin screw C2TX extruder operated at a shaft speed of 950 rpm and a 48% motor load. Water was added to the extruder at a rate of 35 kg/hr. The first and second extruder heads downstream of the inlet head were operated at 64° C. and 110° C., respectively. The outlet end of the extruder was equipped with a variable back pressure valve and a TVP die. The back pressure valve was 99% closed to create back pressure conditions within the extruder barrel. As the product emerged from the die, it was cut using a rotary knife operated at 100 rpm. The final product exhibited good texture as a simulated meat product.

It will also be understood that each of the respective components may be coated with palatability enhancers such as liquid fats, liver digest or any other such additive known in the art.

The combined feed products of the invention have significant storage stability. Generally, these products are shelf-stable at ambient conditions for periods of at least about 3 months, and more preferably at least about 6 months. The presence of the acidulant serves to stabilize water activities in the combined product, whereas the humectant also has this effect as well as serving to soften the rice and TVP components. The simulated food materials also can be stored over long periods of time in conventional packaging without the requirement of refrigeration or other special conditions.

I claim:

1. A combined pet food product comprising respective amounts of an extruded kibble pet food component having individual quantities of protein, fat and starch, an extruded rice component including a rice material and treated with a humectant and an acidulant, and an extruded textured vegetable protein component including textured vegetable protein and treated with a humectant and an acidulant.

2. The combined pet food product of claim 1, said rice component and said textured vegetable protein component each being present at a level of from about 2-40% by weight.

3. The combined pet food product of claim 1, said humectant comprising propylene glycol, and said acidulant comprising phosphoric acid.

4. The combined pet food product of claim 1, said rice component and said textured vegetable protein component having humectant and acidulant dispersed therein.

5. The combined pet food product of claim 1, said rice component and said textured vegetable protein component having humectant and acidulant applied to the surfaces thereof.

6. A combined petfood product comprising respective amounts of a plurality of simulated food materials each separately formed by extrusion, and each having the appearance of the natural food counterpart thereof, said plurality of simulated food materials including at least two different simulated vegetable materials.

7. The combined petfood product of claim 6, said different simulated vegetable materials selected from the group consisting of corn, rice, peas, carrots, and beans.

8. The combined petfood product of claim 6, each of said simulated food materials having the color of the natural food counterpart thereof.

9. The combined petfood product of claim 6, each of said simulated food materials having the taste of the natural food counterpart thereof.

10. The combined petfood product of claim 6, including a simulated meat material having the appearance of the natural meat counterpart thereof.

11. The combined petfood product of claim 10, said simulated meat material having the appearance of a natural meat selected from the group consisting of beef, pork, poultry, lamb, and fish.

12. The combined petfood product of claim 10, said simulated meat material having the color of the natural meat counterpart thereof.

13. The combined petfood product of claim 10, said simulated meat material having the taste of the natural meat counterpart thereof.

14. The combined petfood product of claim 6, including a plurality of simulated meat materials each having the appearance of the natural meat counterpart thereof.

15. The combined petfood product of claim 6, at least certain of said food materials including nutraceuticals.

16. The combined petfood product of claim 15, said nutraceuticals selected from the group consisting of vitamins and minerals.

17. The combined petfood product of claim 6, including a quantity of fresh, naturally occurring meat.

18. The combined petfood product of claim 6, said plurality of simulated food materials being mixed together.

19. The combined petfood product of claim 6, said plurality of simulated food materials being maintained separately in a feeding tray having individual compartments for each of said food materials.
